(19) United States
(12) Patent Application Publication
(10) Pub. No.: US 2026/0127986 A1
(43) Pub. Date: May 7, 2026

(54) MAGNETO-INDUCTIVE DISPLAY PANEL AND MAGNETO-INDUCTIVE DISPLAY DEVICE USING THE SAME

(71) Applicant: EXBRI TECHNOLOGY INC., Hsinchu City (TW)

(72) Inventor: Chao-Yuan Chen, Hsinchu City (TW)

(21) Appl. No.: 19/308,556

(22) Filed: Aug. 25, 2025

(30) Foreign Application Priority Data
Nov. 4, 2024 (CN) 202411559444.9

(51) Int. Cl. G09F 9/37; G09F 9/33; G09G 3/34

(52) U.S. Cl. CPC G09F 9/375; G09F 9/33; G09G 3/3486

(57) ABSTRACT

A magneto-inductive display panel includes: a substrate; a circuit carrier board disposed on the substrate; light-emitting units being disposed on the circuit carrier board and outputting display light; and magnetic sensors, which are disposed on the circuit carrier board and sense magnetic field characteristics of a magnet located around the magnetic sensors to generate magnetic signals, so that state information of the magnet can be determined according to the magnetic signals, thereby achieving a display touch function. This disclosure requires minimal additional steps in manufacturing integration, and enables touch operations without panel contact, while also resolving issues caused by moisture affecting touch performance.

### CROSS-REFERENCE TO RELATED APPLICATIONS

This application claims priority of No. 202411559444.9 filed in China on November 4, 2024 under 35 USC 119, the entire content of which is hereby incorporated by reference.

### FIELD OF THE INVENTION

This disclosure relates to a magneto-inductive display panel and a magneto-inductive display device using the same, and more particularly to a magneto-inductive display panel having magnetic sensors and light-emitting units disposed on a circuit carrier board to achieve touch-sensing and light-emitting display functions, and a magneto-inductive display device using the same.

### DESCRIPTION OF RELATED ART

In terms of touch sensing, touch panels have undergone multiple evolutions from the initial simple single-point touch to today's multi-touch and high-precision touch. Technology has continuously advanced, evolving from resistive touch panels to capacitive touch panels. Most of existing products adopt the capacitive touch panel, which works according to the conductive property of the human skin. When a finger touches a screen, the electric field on the screen changes, allowing the touch position to be detected. However, the capacitive touch technology has high requirements for electro-conductivity, so the finger or a dedicated stylus needs to directly contact the panel. When liquid is present on the panel or the finger is wet, poor touch performance often occurs.

In addition, the capacitive touch panel mainly includes a substrate, an electro-conductive layer, an insulating layer, a protection layer and sensing electrodes stacked sequentially from bottom to top. Numerous components are needed, and the manufacturing cost is high. When the capacitive touch panel is integrated with a display, the display performance may be affected.

Therefore, how to provide a touch display device that overcomes these problems is the issue to be solved by this disclosure.

### SUMMARY OF THE INVENTION

It is therefore an objective of this disclosure to provide a magneto-inductive display panel having magnetic sensors and light-emitting units disposed on a circuit carrier board to achieve touch sensing and light-emitting display functions, and a magneto-inductive display device using the same. An embodiment of this disclosure requires minimal additional steps in manufacturing integration, and enables touch operations without panel contact, while also resolving issues caused by moisture affecting touch performance.

To achieve the above-identified objective, this disclosure provides a magneto-inductive display panel including: a substrate; a circuit carrier board disposed on the substrate; light-emitting units being disposed on the circuit carrier board and outputting display light; and magnetic sensors, which are disposed on the circuit carrier board and sense magnetic field characteristics of a magnet located around the magnetic sensors to generate magnetic signals, so that state information of the magnet can be determined according to the magnetic signals.

Preferably, the magneto-inductive display panel further includes a protective cover plate disposed above the light-emitting units and the magnetic sensors, wherein the magnet is disposed on or above the protective cover plate.

Preferably, the magneto-inductive display panel further includes: a reflective sheet, wherein the magnetic sensors, the circuit carrier board and the light-emitting units are disposed between the reflective sheet and the substrate, the substrate is a metallic backing plate, the reflective sheet has through holes, and the display light passes through each of the through holes.

Preferably, the magneto-inductive display panel further includes: a lower optical film disposed above the reflective sheet; a liquid crystal display layer disposed above the lower optical film; and an upper optical film disposed above the liquid crystal display layer and below the protective cover plate

Preferably, the magnet is disposed below or beside the magnetic sensors.

Preferably, the circuit carrier board includes: longitudinal circuit boards, wherein the light-emitting units and the magnetic sensors are disposed on the longitudinal circuit boards; transversal circuit boards electrically connected to the longitudinal circuit boards; and a control board being electrically connected to the transversal circuit boards and controlling the light-emitting units and the magnetic sensors to operate.

Preferably, the substrate includes a ferroelectric material, the substrate has through holes respectively disposed below the magnetic sensors, and each of the through holes is greater than one fifteenth of a gap between adjacent two of the magnetic sensors

Preferably, the magneto-inductive display panel further includes a processor, which is electrically connected to the magnetic sensors, and determines, according to the magnetic signals, the state information of the magnet to generate an operation signal.

This disclosure provides a magneto-inductive display device, including: the magneto-inductive display panel; and a first operation component comprising a body, and the magnet disposed on one end of the body.

Preferably, the first operation component further includes a second magnet disposed on the other end of the body, and the second magnet and the magnet have different magnetic flux characteristics.

Preferably, a distance between the magnet and the second magnet is greater than one-half of a distance between adjacent two of the magnetic sensors.

Preferably, the magnetic sensors sense magnetic field characteristics of the second magnet to generate second magnetic signals, and the processor determines, according to the second magnetic signals, second state information of the magnet to generate a second operation signal.

Preferably, the body is substantially parallel to the circuit carrier board, so that the magnet and the second magnet are at substantially a same distance from the circuit carrier board, and when the body is rotated substantially parallel to the circuit carrier board, the processor causes rotating or zooming of a screen on the magneto-inductive display panel according to the operation signal and the second operation signal.

Preferably, the body is substantially parallel to the circuit carrier board, and is moved in a direction toward or away from the circuit carrier board, and the processor causes zooming of a screen on the magneto-inductive display panel according to the operation signal and the second operation signal.

Preferably, the body is moved substantially parallel to the circuit carrier board, the processor according to the operation signal and the second operation signal causes panning of a screen on the magneto-inductive display panel.

Preferably, the magneto-inductive display device further includes: a second operation component including a second body, and a third magnet and a fourth magnet respectively disposed on two ends of the second body, wherein the magnet, the second magnet, the third magnet and the fourth magnet have different magnetic flux characteristics, and the magnetic sensors respectively sense the magnetic field characteristics of the third magnet and the fourth magnet and generate a third operation signal and a fourth operation signal.

Preferably, the processor causes rotating of a screen on the magneto-inductive display panel according to the operation signal and the third operation signal representing that the magnet and the third magnet remain stationary above the circuit carrier board for a period exceeding a predetermined time and then constitute a rotation behavior.

Preferably, the processor causes zooming-out of a screen on the magneto-inductive display panel according to the operation signal and the third operation signal representing that the magnet and the third magnet remain stationary above the circuit carrier board for a period exceeding a predetermined time and then approach each other.

Preferably, the processor causes zooming-in of a screen on the magneto-inductive display panel according to the operation signal and the third operation signal representing that the magnet and the third magnet remaining stationary above the circuit carrier board for a period exceeding a predetermined time and then move away from each other.

Preferably, the processor causes a specific function according to a condition representing that the magnet and the third magnet respectively remain stationary above and below the circuit carrier board.

Preferably, the processor causes a specific function according to a condition representing that the magnet and the third magnet respectively remain stationary above and beside the circuit carrier board.

With the above-mentioned embodiments, magnetic sensors can be mounted in redundant spaces on the circuit carrier board on which the light-emitting units are mounted, so that the magnetic sensors can sense magnetic field characteristics of the magnet to generate the magnetic signals, according to which the state information of the magnet can be determined, thereby achieving a display touch function.

In order to make the above-mentioned contents of this disclosure be more clearly understood, preferred embodiments are given below with reference to the accompanying drawings for detailed description.

### BRIEF DESCRIPTION OF DRAWINGS

In order to illustrate the embodiments of this disclosure or the technical solutions in the prior art more clearly, a brief introduction is given below to the drawings required in the embodiments or the description of the prior art. Obviously, the drawings described below relate to some embodiments of this disclosure. For those of ordinary skill in the art, other drawings can be obtained from these drawings without creative efforts.

FIG. 1 is a schematic front view showing a magneto-inductive display device according to a preferred embodiment of this disclosure.

FIG. 2 is a schematic front view showing a modified example of the magneto-inductive display device of FIG. 1.

FIG. 3 is a schematic top view showing another modified example of the magneto-inductive display device of FIG. 1.

FIGS. 4 to 7 are schematic views showing applications of the magneto-inductive display device according to the preferred embodiment of this disclosure.

FIG. 8 is a schematic partial front view showing still another modified example of the magneto-inductive display device of FIG. 1.

### DETAILED DESCRIPTION OF THE INVENTION

To better illustrate the objectives, technical solutions and advantages of this disclosure, the following description details the technical solutions of the embodiments of this disclosure with reference to the accompanying drawings. Obviously, the described embodiments are merely a portion of this disclosure, but not all the embodiments. Based on the embodiments of this disclosure, all other embodiments obtained by those skilled in the art without creative efforts still fall within the scope of this disclosure.

In addition, ranges for quantities, ratios, and other numerical values may be sometimes presented in range formats throughout this disclosure. It should be understood that such range formats are provided for convenience and conciseness, and should be interpreted flexibly to include not only the numerical values explicitly specified as range limits but also all individual numbers or sub-ranges within said ranges, as if each number and sub-range were expressly specified.

This disclosure mainly utilizes magnetic sensors to sense one or more magnets and then generate signals that locate the position(s) of the magnet(s). The magnetic sensor can sense the geomagnetism and output signals representing the intensity and direction of the magnetic field. Collecting signals from the magnetic sensors allows for calculating the position, orientation and intensity of the magnet using methods similar to triangulation. Positioning can be performed according to the position information; and identification can be performed according to the orientation and intensity. Different magnets can be collective used to produce diverse functionalities.

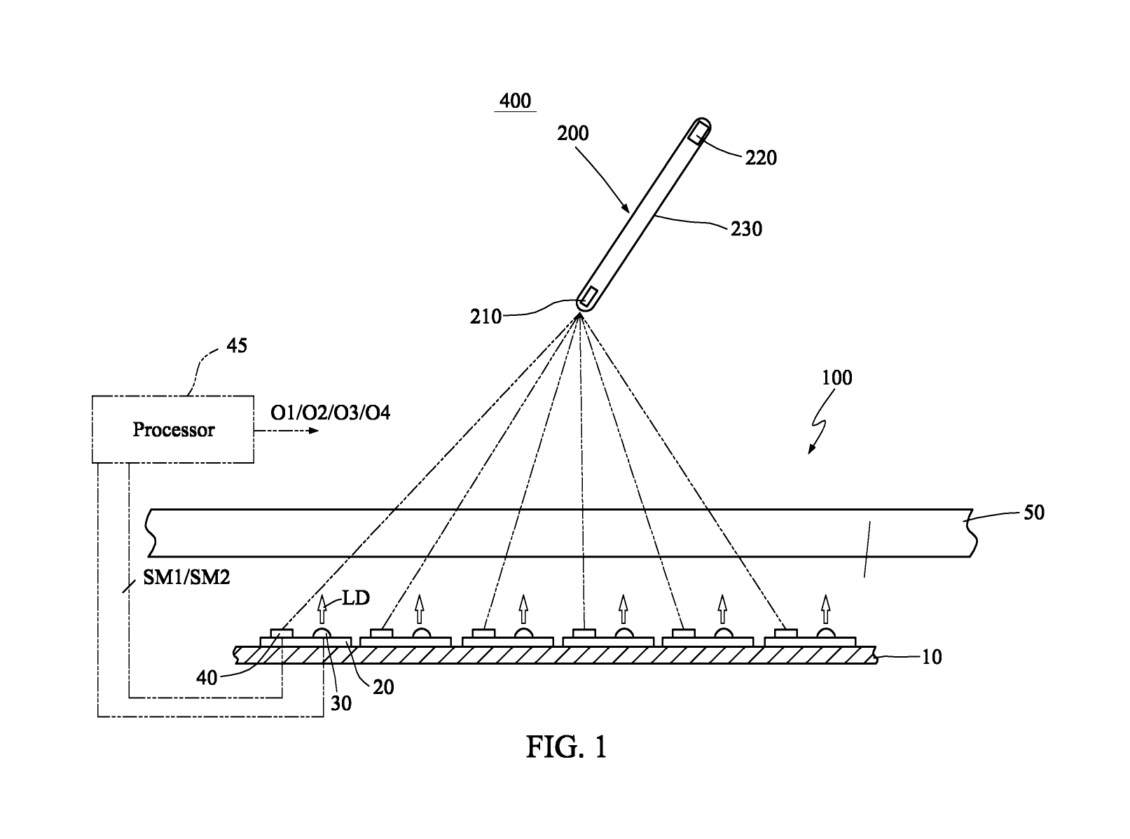

FIG. 1 is a schematic front view showing a magneto-inductive display device 400 according to a preferred embodiment of this disclosure. Referring to FIG. 1, the magneto-inductive display device 400 includes a magneto-inductive display panel 100 and a first operation component 200. The first operation component 200 includes a body 230, and a magnet 210 disposed on one end of the body 230. The magneto-inductive display panel 100 includes a substrate 10, a circuit carrier board 20, light-emitting units 30 and magnetic sensors 40. In this example, the magneto-inductive display panel 100 further includes a protective cover plate 50, which may be omitted according to requirements without affecting the magnetic sensing function. Based on the signals obtained after the magnetic sensors 40 have sensed the magnet 210, the position of the head of the first operation component 200 can be obtained.

The circuit carrier board 20 is disposed on the substrate 10. The light-emitting units 30 are, for example, light-emitting diodes (LEDs) being disposed on the circuit carrier board 20 and outputting display light LD. The display light LD can directly reach the user's eye, or indirectly reach the user's eye through an optical function layer, but the invention is not restricted thereto. In one example, the circuit carrier board 20 is a flexible printed circuit board (FPCB), and the combination of the LEDs and the FPCB may be referred to as an LED strip. The display light LD may be used for direct or indirect display, but the invention is not particularly restricted thereto.

The magnetic sensors 40 are disposed on the circuit carrier board 20. In actual manufacturing, surface mount technology (SMT) may be adopted to mount the light-emitting units 30 and the magnetic sensors 40 on the circuit carrier board 20, achieving both installation and electrical connection effects simultaneously. Even without the magnetic sensors 40, SMT is still required to mount the light-emitting units 30.Therefore, when implementing this disclosure, only the magnetic sensors 40 need to be additionally mounted during the mounting of the light-emitting units 30, without increasing the cost of an additional circuit board. It can be understood that in another example, wafer-level manufacturing processes can be used to manufacture the light-emitting units 30 and the magnetic sensors 40 to produce small magnetic sensing display panels.

An optional protective cover plate 50 is disposed above the light-emitting units 30 and the magnetic sensors 40. It is understandable that other elements or structures, including but without limitation to, optical devices/structures, electrical elements/structures, circuit structures and the like, may be disposed between the substrate 10 and the protective cover plate 50. The magnetic sensors 40 sense magnetic field characteristics of the magnet 210 located around the magnetic sensors 40, and generate magnetic signals SM1, so that state information of the magnet 210 can be determined according to the magnetic signals SM1. In this non-restrictive example, the magnet 210 is disposed above the magnetic sensor 40, disposed above the circuit carrier board 20 and disposed on or above the protective cover plate 50.

Optionally, the magneto-inductive display panel 100 further includes a processor 45, which is electrically connected to the magnetic sensors 40, and determines, according to the magnetic signals SM1, the state information of the magnet 210 to generate an operation signal O1. It is understood that the magneto-inductive display panel 100 does not necessarily include the processor 45 because a processor of an electronic apparatus installed with the magneto-inductive display panel 100 can perform the work of the processor 45.

The first operation component 200 further includes a second magnet 220 disposed on the other end of the body 230, and the second magnet 220 and the magnet 210 have different magnetic flux characteristics. The distance between the magnet 210 and the second magnet 220 is greater than one-half (1/2) of the distance between adjacent two of the magnetic sensors 40 to provide an appropriate resolution. This is because when the above-mentioned condition is not met, and both the magnet 210 and the second magnet 220 are located between the two magnetic sensors 40, the state information cannot be correctly determined according to the magnetic signals of the magnetic sensors 40. Therefore, the magnetic sensors 40 sense magnetic field characteristics of the second magnet 220 to generate second magnetic signals SM2, and the processor 45 determines, according to the second magnetic signals SM2, state information of the second magnet 220 to generate a second operation signal O2. For example, the magnet 210 is a magnet exhibiting a higher magnetic field strength, with its poles represented as N1 and S1, and the second magnet 220 is a magnet exhibiting a lower magnetic field strength, with its poles represented as N2 and S2. Based on permutations and combinations, there are four conditions: N1 and N2 facing outwards from the first operating component (e.g., N1 and N2 are disposed in a back-to-back manner in the longitudinal direction of the first operating component); N1 and S2 facing outwards from the first operating component; N1 and N2 facing inwards from the first operating component (e.g., N1 and N2 are disposed in a face-to-face manner in the longitudinal direction of the first operating component); and N1 and S2 facing inwards from the first operating component. Therefore, four types of first operating components can be manufactured for users to select according to different conditions. In addition, since the magnetic flux intensity is inversely proportional to the cube of the distance, it is possible to obtain which operation component is used and where the operation component is located according to the magnetic flux intensity and the angles of the magnetic lines of force. According to the signals of the magnetic sensors 40, it is also possible to identify which operation component is currently used. For example, four first operating components may represent functions of different colors or different movement/rotation amplitudes, including but not limited to a wiper or a shuttle (shuttle wheel or rotary knob). It is understood that the first operation component 200 does not necessarily include the second magnet 220.

In this embodiment, the state information includes, but is not limited to, the distance between the magnet and each magnetic sensor, and the state (or posture) of the magnet can be determined based on the distance between the N/S pole of the magnet and each magnetic sensor. The state information also includes static and dynamic information. According to the above-mentioned embodiment, a magneto-inductive display device that replaces capacitive touch technology can be provided, solving the problem of poor touch performance caused by liquid or wet fingers on the panel, and the magnet does not need to directly contact the protective cover plate.

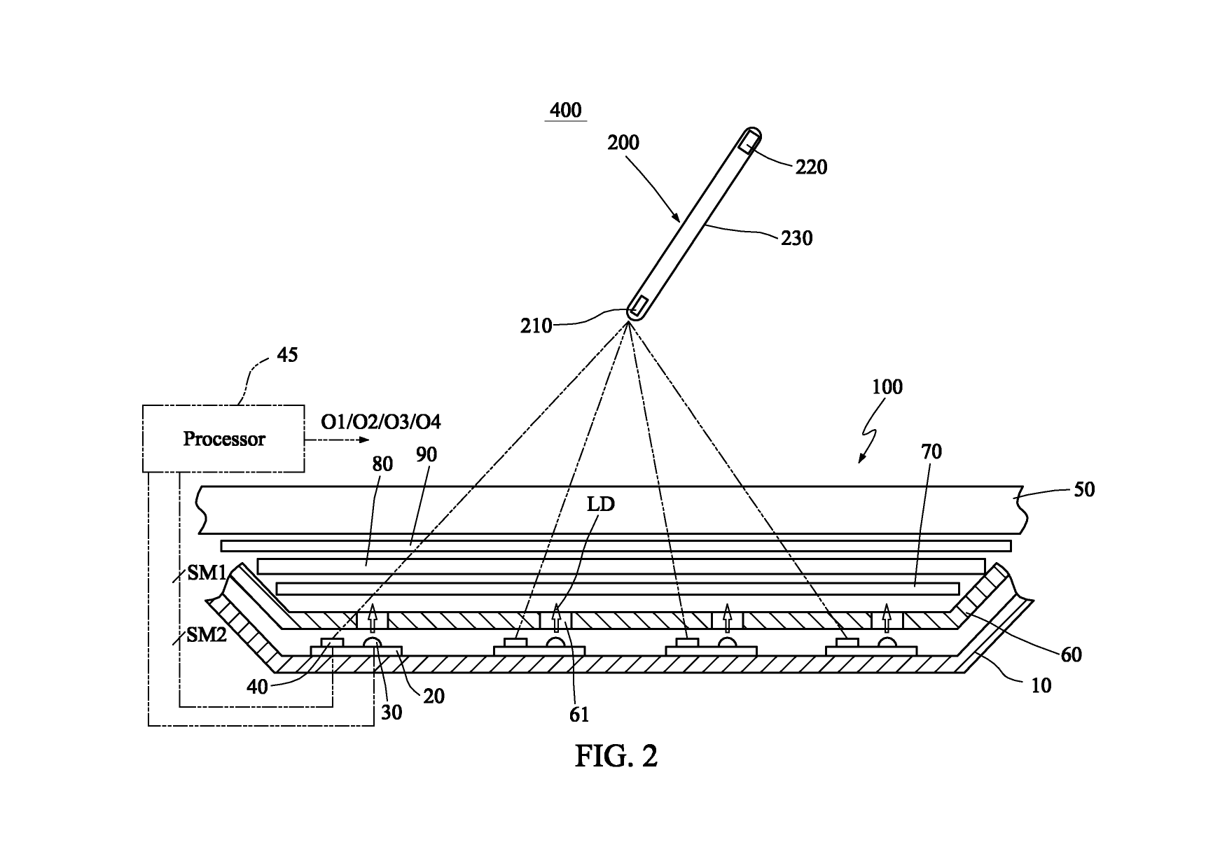

FIG. 2 is a schematic front view showing a modified example of the magneto-inductive display device of FIG. 1. Referring to FIG. 2, similar to the direct-display type display panel of FIG. 1, the magneto-inductive display panel 100 of the FIG. 2 is a display panel utilizing a bottom lighting backlight module, and the magneto-inductive display panel 100 further includes a reflective sheet 60. The magnetic sensors 40, the circuit carrier board 20 and the light-emitting units 30 are disposed between the reflective sheet 60 and the substrate 10. In this example, the substrate 10 is a metallic backing plate made of a non-ferroelectric material, and the reflective sheet 60 has through holes 61, through each of which the display light LD passes. In another example, the substrate 10 is made of a non-ferromagnetic plastic, glass or any other suitable material. Optionally, the reflective sheet 60 is a reflective film closely attached to the circuit carrier board 20 with the through holes 61 formed only above the light-emitting units 30 to allow the light to pass through.

In addition, the magneto-inductive display panel 100 further includes a lower optical film 70, a liquid crystal display layer 80 and an upper optical film 90. The lower optical film 70 is disposed above the reflective sheet 60. The liquid crystal display layer 80 is disposed above the lower optical film 70.The upper optical film 90 is disposed above the liquid crystal display layer 80 and below the protective cover plate 50. Thus, the magneto-inductive liquid crystal display panel can be implemented. It is understood that direct contact, or indirect contact (through adhesives or any other optical layer, structure layer or wire layer) may be present between the protective cover plate 50, the reflective sheet 60, the lower optical film 70, the liquid crystal display layer 80 and the upper optical film 90, but the invention is not restricted thereto. It is understood that each of the lower optical film 70 and the upper optical film 90 may include multiple functional optical films stacked or laminated together to achieve the backlight and display purposes. In one example, a diffusion film and a light enhancing film can achieve the backlight purpose, and a polarizer can achieve the display purpose.

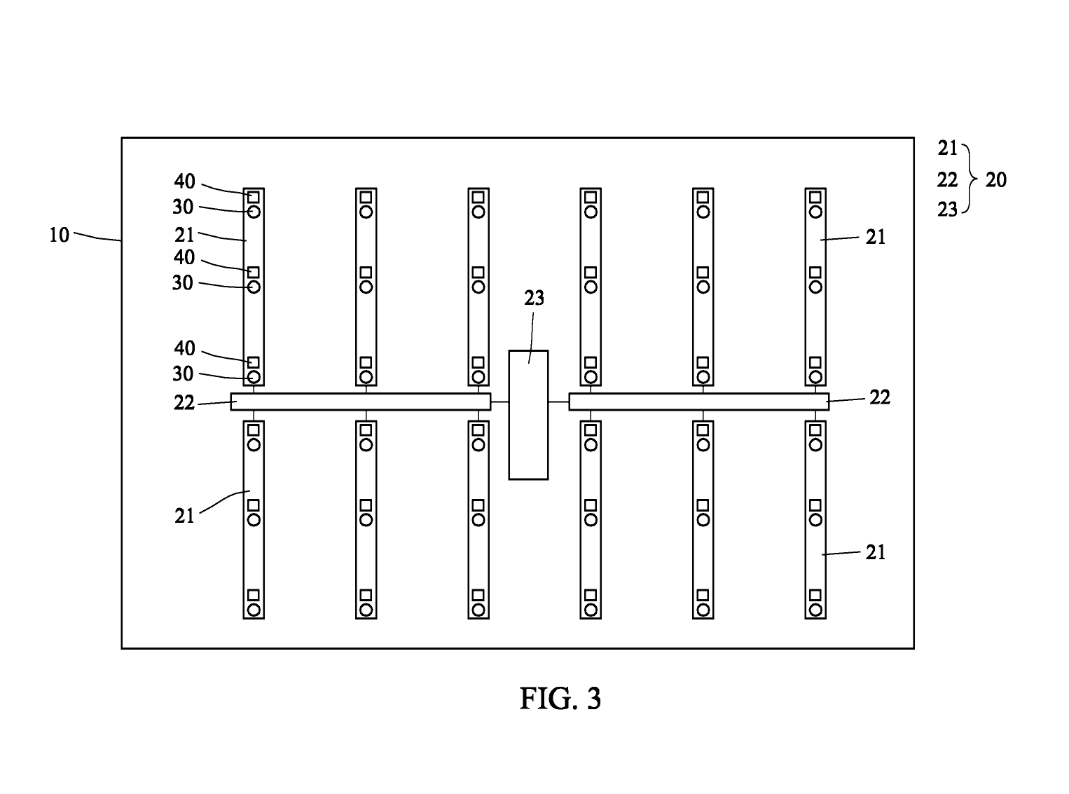

FIG. 3 is a schematic top view showing another modified example of the magneto-inductive display device of FIG. 1. Referring to FIG. 3, the circuit carrier board 20 includes longitudinal circuit boards 21, transversal circuit boards 22 and a control board 23. The light-emitting units 30 and the magnetic sensors 40 are disposed on the longitudinal circuit boards 21. The transversal circuit boards 22 are electrically connected to the longitudinal circuit boards 21. The control board 23 is electrically connected to the transversal circuit boards 22 and controls operations of the light-emitting units 30 and the magnetic sensors 40. It is understood that the transversal circuit boards 22, the longitudinal circuit boards 21 and the control board 23 may also be integrated into a circuit board. It is understood that the magnetic sensors 40 and the light-emitting units 30 are not restricted to having the matched quantities or having the correspondingly adjacent positions as long as the mounting positions do not conflict and the required magnetic sensing effect can be achieved.

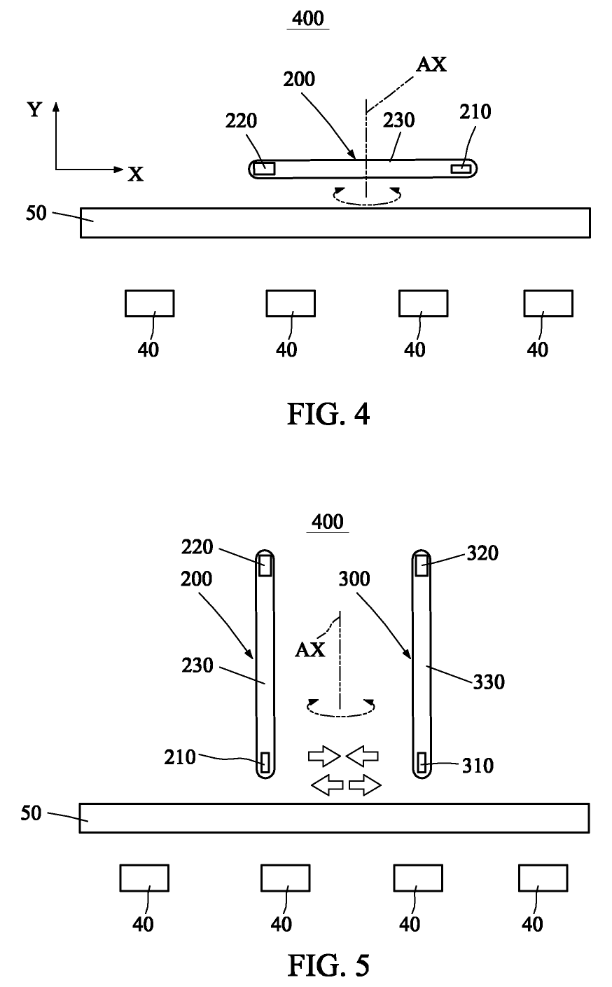

FIGS. 4 to 7 are schematic views showing applications of the magneto-inductive display device according to the preferred embodiment of this disclosure. Referring to FIGS. 4 and 1, when the body 230 is substantially parallel to the circuit carrier board 20 or the protective cover plate 50, the magnet 210 and the second magnet 220 are located at substantially a same distance from the circuit carrier board 20 or the protective cover plate 50. When the user operates the first operation component 200 such that the body 230 is rotated substantially parallel to the circuit carrier board 20 or the protective cover plate 50, the processor 45 causes rotating or zooming of a screen on the magneto-inductive display panel 100 according to the operation signal O1 and the second operation signal O2. For example, when the first operation component 200 is sensed or detected as rotating in a clockwise/counterclockwise direction, the screen or frame is rotated in the clockwise/counterclockwise direction. Alternatively, when the first operation component 200 is detected as rotating in the clockwise/counterclockwise direction, the screen or frame is zoomed out/in. In another example, after the first operation component 200 is placed horizontally, the level of zooming-in or zooming-out of the screen can be defined based on the distance from the first operation component 200 to the magneto-inductive display panel 100. That is, when the first operation component 200 is rotated, the screen is rotated; when the first operation component 200 is moved forward (upward and away from the magneto-inductive display panel 100), the screen is zoomed out; when the first operation component 200 is moved backward (downward and toward the magneto-inductive display panel 100), the screen is zoomed in; and when the first operation component 200 is moved on a plane in a front, back, left or right direction, the screen is panned. That is, when the body 230 is substantially parallel to the circuit carrier board 20 and moved toward or away from the circuit carrier board 20, the processor 45 causes zooming of the screen according to the operation signal O1 and the second operation signal O2; or when the body 230 is moved substantially parallel to the circuit carrier board 20, the processor 45 causes panning of the screen according to the operation signal O1 and the second operation signal O2. The magnetic sensors 40 are arranged in an array, and can obtain an array of sensing data by sensing the positions of the magnet 210 and the second magnet 220. The sensing data can be processed to obtain the state information of the first operation component 200, which is feasible in practice.

Referring to FIGS. 5 and 1, the magneto-inductive display device 400 further includes a second operation component 300. The second operation component 300 includes a second body 330, and a third magnet 310 and a fourth magnet 320 respectively disposed on two ends of the second body 330. The magnet 210, the second magnet 220, the third magnet 310 and the fourth magnet 320 have different magnetic flux characteristics. The magnetic sensors 40 respectively sense magnetic field characteristics of the third magnet 310 and the fourth magnet 320, and thus generate a third operation signal O3 and a fourth operation signal O4. The appearance size or color of the second operation component 300 may be designed to be different from that of the first operation component 200, so that the user can distinguish them from each other. Using two operation components enables multi- point touch inputs for controlling rotating, scaling, panning, and other touch behaviors. It is understood that a third operation component, a fourth operation component and the like may also be added.

In one example, the processor 45 causes rotating of the screen on the magneto-inductive display panel 100 according to the operation signal O1 and the third operation signal O3 representing that the magnet 210 and the third magnet 310 remain (or stay) stationary on (or above) the circuit carrier board 20 or the protective cover plate 50 for a period exceeding a predetermined time (may be set to range from 2 to 4 seconds or the like) and then constitute a rotation behavior (e.g., an arc-like trace is formed by the movements of the two magnets).

In another example, the processor 45 causes zooming-out of the screen on the magneto-inductive display panel 100 according to the operation signal O1 and the third operation signal O3 representing that the magnet 210 and the third magnet 310 remain stationary on or above the circuit carrier board 20 or the protective cover plate 50 for a period exceeding a predetermined time and then approach each other.

In still another example, processor 45 causes zooming-in of the screen on the magneto-inductive display panel 100 according to the operation signal O1 and the third operation signal O3 representing that the magnet 210 and the third magnet 310 remain stationary on or above the circuit carrier board 20 or the protective cover plate 50 for a period exceeding a predetermined time and then move away from each other.

In other examples, the processor 45 performs an object selection operation according to the operation signal O1 and the third operation signal O3 representing that the magnet 210 and the third magnet 310 remain stationary on or above the circuit carrier board 20 or the protective cover plate 50 for a period exceeding a predetermined time.

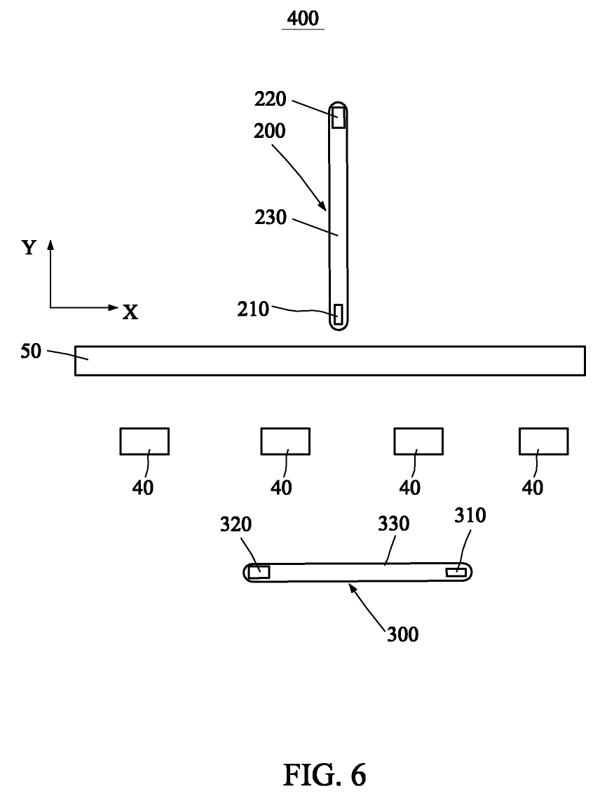

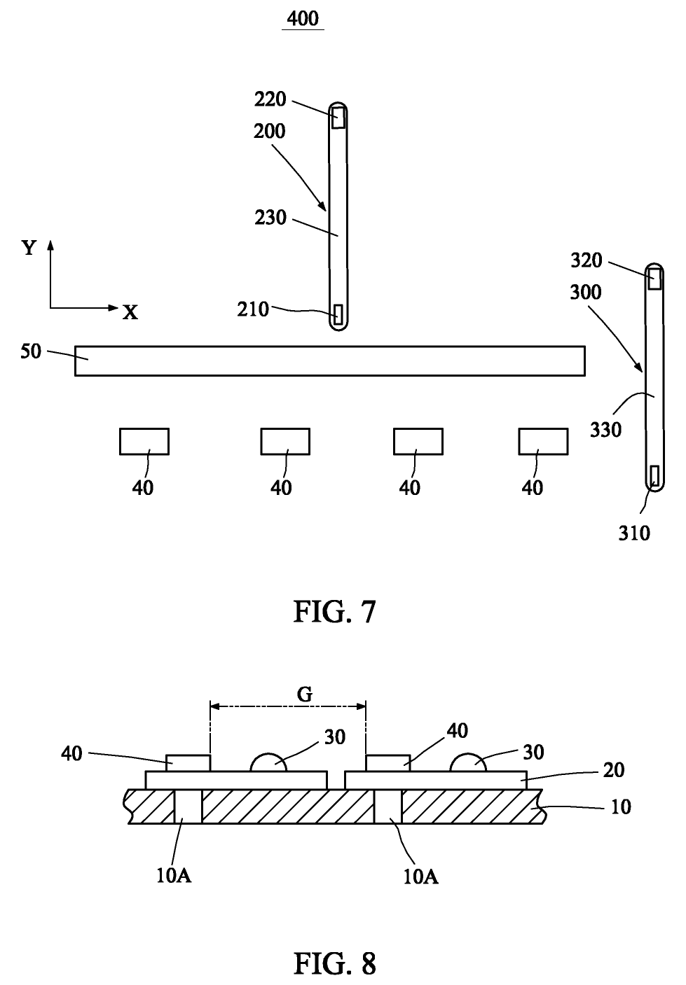

The above-mentioned example is explained with the magnet being located above the magnetic sensors. In practical applications, however, the magnet may be disposed above, below or beside the magnetic sensors (e.g., to the front, back, left or right side of the magnetic sensors). Referring to FIG. 6, the second operation component 300 may be placed below the magnetic sensors 40, as shown in FIG. 7, the second operation component 300 may be placed beside the magnetic sensors 40 and works in conjunction with the first operation component 200 located above the magnetic sensor 40 to achieve one of specific functions of an operation component of an eraser, a specific color and the like. Therefore, the processor 45 can cause or enable a specific function (may be configured by the system or the user) according to a condition representing that the magnet 210 and the third magnet 310 respectively remain stationary above, below and beside the circuit carrier board 20.

FIG. 8 is a schematic partial front view showing still another modified example of the magneto-inductive display device of FIG. 1. Referring to FIG. 8, the substrate 10 is made of a ferroelectric material. In this case, through holes 10A below the magnetic sensors are formed in the substrate 10. Because the ferroelectric material affects the sensing values of the magnetic sensors, it must be located away from the magnetic sensors to avoid affecting the magnetic field around the magnetic sensors. According to testing performed by the inventor, the radius of the through hole 10A should be greater than one fifteenth (1/15) of the gap G between the magnetic sensors, or even one tenth (1/10) or one fifth (1/5) of the gap G, and can be determined according to the actual design condition.

It is understood that although the above-mentioned embodiment is explained with a pen serving as the operation component, this disclosure is not restricted thereto. In other examples, the operation component may also be presented as an eraser or a shuttle (shuttle wheel) for performing wiping or rotating operations. When the operation component is the eraser or the shuttle, the body is provided with a magnet having a larger area or multiple magnets arranged in a specific pattern or array. In addition, the pen is not limited to have two heads; having three or more heads also falls within the scope of embodiments of this disclosure.

With the above-mentioned embodiment, the magnetic sensors can be mounted in redundant spaces on the circuit carrier board on which the light-emitting units are mounted, so that the magnetic sensors can sense magnetic field characteristics of the magnet to generate the magnetic signals, according to which the state information of the magnet can be determined, thereby achieving the display touch function. In addition, because the operation component is provided with the permanent magnet, the battery and chip are not required, and the magnetic sensors also need not to emit electromagnetic waves to the magnet, thereby saving the cost.

It is worth noting that all the above embodiments can be combined, replaced or modified interactively as appropriate to provide diversified combination effects.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. A magneto-inductive display panel, comprising:
a substrate;
a circuit carrier board disposed on the substrate;
light-emitting units being disposed on the circuit carrier board and outputting display light; and
magnetic sensors, which are disposed on the circuit carrier board and sense magnetic field characteristics of a magnet located around the magnetic sensors to generate magnetic signals, so that state information of the magnet can be determined according to the magnetic signals.

2. The magneto-inductive display panel according to claim 1, further comprising a protective cover plate disposed above the light-emitting units and the magnetic sensors, wherein the magnet is disposed on or above the protective cover plate.

3. The magneto-inductive display panel according to claim 2, further comprising:
a reflective sheet, wherein the magnetic sensors, the circuit carrier board and the light-emitting units are disposed between the reflective sheet and the substrate, the substrate is a metallic backing plate, the reflective sheet has through holes, and the display light passes through each of the through holes.

4. The magneto-inductive display panel according to claim 3, further comprising:
a lower optical film disposed above the reflective sheet;
a liquid crystal display layer disposed above the lower optical film; and
an upper optical film disposed above the liquid crystal display layer and below the protective cover plate.

5. The magneto-inductive display panel according to claim 1, wherein the magnet is disposed below or beside the magnetic sensors.

6. The magneto-inductive display panel according to claim 1, wherein the circuit carrier board comprises:
longitudinal circuit boards, wherein the light-emitting units and the magnetic sensors are disposed on the longitudinal circuit boards;
transversal circuit boards electrically connected to the longitudinal circuit boards; and
a control board being electrically connected to the transversal circuit boards and controlling the light-emitting units and the magnetic sensors to operate.

7. The magneto-inductive display panel according to claim 1, wherein the substrate comprises a ferroelectric material, the substrate has through holes respectively disposed below the magnetic sensors, and each of the through holes is greater than one fifteenth of a gap between adjacent two of the magnetic sensors.

8. The magneto-inductive display panel according to claim 1, further comprising a processor, which is electrically connected to the magnetic sensors, and determines, according to the magnetic signals, the state information of the magnet to generate an operation signal.

9. A magneto-inductive display device, comprising:
the magneto-inductive display panel according to claim 8; and
a first operation component comprising a body, and the magnet disposed on one end of the body.

10. The magneto-inductive display device according to claim 9, wherein the first operation component further comprises a second magnet disposed on the other end of the body, and the second magnet and the magnet have different magnetic flux characteristics.

11. The magneto-inductive display device according to claim 10, wherein a distance between the magnet and the second magnet is greater than one-half of a distance between adjacent two of the magnetic sensors.

12. The magneto-inductive display device according to claim 10, wherein the magnetic sensors sense magnetic field characteristics of the second magnet to generate second magnetic signals, and the processor determines, according to the second magnetic signals, second state information of the magnet to generate a second operation signal.

13. The magneto-inductive display device according to claim 12, wherein the body is substantially parallel to the circuit carrier board, so that the magnet and the second magnet are at substantially a same distance from the circuit carrier board, and when the body is rotated substantially parallel to the circuit carrier board, the processor causes rotating or zooming of a screen on the magneto-inductive display panel according to the operation signal and the second operation signal.

14. The magneto-inductive display device according to claim 12, wherein the body is substantially parallel to the circuit carrier board, and is moved in a direction toward or away from the circuit carrier board, and the processor causes zooming of a screen on the magneto-inductive display panel according to the operation signal and the second operation signal.

15. The magneto-inductive display device according to claim 12, wherein the body is moved substantially parallel to the circuit carrier board, the processor according to the operation signal and the second operation signal causes panning of a screen on the magneto-inductive display panel.

16. The magneto-inductive display device according to claim 10, further comprising:
a second operation component comprising a second body, and a third magnet and a fourth magnet respectively disposed on two ends of the second body, wherein the magnet, the second magnet, the third magnet and the fourth magnet have different magnetic flux characteristics, and the magnetic sensors respectively sense the magnetic field characteristics of the third magnet and the fourth magnet and generate a third operation signal and a fourth operation signal.

17. The magneto-inductive display device according to claim 16, wherein the processor causes rotating of a screen on the magneto-inductive display panel according to the operation signal and the third operation signal representing that the magnet and the third magnet remain stationary above the circuit carrier board for a period exceeding a predetermined time and then constitute a rotation behavior.

18. The magneto-inductive display device according to claim 16, wherein the processor causes zooming-out of a screen on the magneto-inductive display panel according to the operation signal and the third operation signal representing that the magnet and the third magnet remain stationary above the circuit carrier board for a period exceeding a predetermined time and then approach each other.

19. The magneto-inductive display device according to claim 16, wherein the processor causes zooming-in of a screen on the magneto-inductive display panel according to the operation signal and the third operation signal representing that the magnet and the third magnet remain stationary above the circuit carrier board for a period exceeding a predetermined time and then move away from each other.

20. The magneto-inductive display device according to claim 16, wherein the processor causes a specific function according to a condition representing that the magnet and the third magnet respectively remain stationary above and below the circuit carrier board.

21. The magneto-inductive display device according to claim 16, wherein the processor causes a specific function according to a condition representing that the magnet and the third magnet respectively remain stationary above and beside the circuit carrier board.
